(19) United States
(12) Patent Application Publication
(10) Pub. No.: US 2026/0040081 A1
(43) Pub. Date: Feb. 5, 2026

(54) TRAFFIC IDENTIFIER OBFUSCATION

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Jerome HENRY, Pittsboro, NC (US); Federico LOVISON, Fontanelle (IT); Javier I. CONTRERAS ALBESA, Sant Cugat del Valles (ES)

(21) Appl. No.: 19/264,795

(22) Filed: Jul. 9, 2025

Related U.S. Application Data
(60) Provisional application No. 63/678,011, filed on Jul. 31, 2024.

(51) Int. Cl. H04W 12/69; H04W 12/02; H04W 12/0431

(52) U.S. Cl. CPC H04W 12/69; H04W 12/02; H04W 12/0431

(57) ABSTRACT

The present disclosure provides techniques for TID obfuscation. A network device generates a first transformation matrix comprising a plurality of rows and a plurality of columns, each row corresponding to a real traffic identifier (TID) value, and each column corresponding to an epoch identifier within a sequence of epochs. The network device populates each entry of the first transformation matrix with an over-the-air-TID (OTA-TID) value, where each OTA-TID value is mapped from a respective TID and a respective epoch identifier. The network device transmits the first transformation matrix to a station (STA).

### CROSS-REFERENCE TO RELATED APPLICATIONS

This application claims benefit of co-pending U.S. provisional patent application Ser. No. 63/678,011 filed Jul. 31, 2024. The aforementioned related patent application is herein incorporated by reference in its entirety.

### TECHNICAL FIELD

Embodiments presented in this disclosure generally relate to wireless communication. More specifically, embodiments disclosed herein relate to traffic identifier (TID) obfuscation in wireless networks.

### BACKGROUND

IEEE 802.11bi introduces privacy enhancements aimed at minimizing the trackability of stations (STAs) by eavesdroppers and peer STAs within the same extended service set (ESS). To achieve this goal, the standard mandates obfuscation or anonymization of protocol elements that may expose personal identifiable information (PII). There are several techniques that have been proposed for obfuscating MAC addresses and other identifying fields at the MAC and PHY layers. However, no mechanism has been introduced to address traffic identifier (TID) obfuscation.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless environment illustrating TID obfuscation in data frames exchanged between a station (STA) and an access point (AP), according to some embodiments of the present disclosure.

FIG. 2 depicts an example transformation matrix used for TID obfuscation, according to some embodiments of the present disclosure.

FIG. 3 depicts an example of algorithmic TID obfuscation using a shared seed, according to some embodiments of the present disclosure.

FIG. 4 depicts an example of XOR-based TID obfuscation using a bitstream chunk, according to some embodiments of the present disclosure.

FIG. 5 depicts an example of per-frame XOR-based TID obfuscation using a bitstream chunk, according to some embodiments of the present disclosure.

FIG. 6A depicts an example method for generating and distributing a TID transformation matrix, according to some embodiments of the present disclosure.

FIG. 6B depicts an example method for resolving a real TID from a received OTA-TID using a TID transformation matrix, according to some embodiments of the present disclosure.

FIG. 7 depicts an example method for resolving a real TID from a received OTA-TID using algorithmic mapping based on a shared seed, according to some embodiments of the present disclosure.

FIG. 8 depicts an example method for resolving a real TID from a received OTA-TID using XOR-based obfuscation and a shared bitstream, according to some embodiments of the present disclosure.

FIG. 9 is a block diagram depicting a method for TID transformation matrix generation, according to some embodiments of the present disclosure.

FIG. 10 is a block diagram depicting a method for TID permutation array generation, according to some embodiments of the present disclosure.

FIG. 11 is a block diagram depicting a method for bitstream generation and TID recovery using XOR-based obfuscation, according to some embodiments of the present disclosure.

FIG. 12 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including generating, by a network device, a first transformation matrix comprising a plurality of rows and a plurality of columns, each row corresponding to a real traffic identifier (TID) value, and each column corresponding to an epoch identifier within a sequence of epochs, populating, by the network device, each entry of the first transformation matrix with an over-the-air-TID (OTA-TID) value, where each OTA-TID value is mapped from a respective TID and a respective epoch identifier, and transmitting, by the network device, the first transformation matrix to a station (STA).

One embodiment presented in this disclosure provides a method, including establishing, between a network device and a station (STA), a shared cryptographic key, and generating, by the network device, a first array of over-the-air-traffic identifier (OTA-TID) values by permuting a set of real traffic identifier (TID) values using a cryptographic function applied to the shared cryptographic key and a current epoch identifier, wherein the first array defines a mapping from each real TID value to a corresponding OTA-TID value for a current epoch.

One embodiment presented in this disclosure provides a method, including establishing, between a network device and a station (STA), a shared seed value, generating, by the network device, using the shared seed value, a bitstream of pseudorandom bits using a cryptographic function, receiving, by the network device, a data frame comprising an over-the-air-traffic identifier (OTA-TID) value and a current epoch identifier, selecting, by the network device, a portion of the bitstream based on the current epoch identifier, and recovering, by the network device, a real TID value corresponding to the OTA-TID value by applying a transformation operation to the OTA-TID value and the selected portion of the bitstream.

### EXAMPLE EMBODIMENTS

Wireless communication standards are increasingly prioritizing user privacy by reducing the ability to track stations (STAs) across time and across the extended service set (ESS). In particular, IEEE 802.11bi introduces a privacy-enhanced framework that seeks to mitigate the risk of STA identification or correlation by external observers, including passive eavesdroppers and neighboring STAs.

Although MAC address randomization and other PHY-level obfuscation strategies have been proposed, the traffic identifier (TID) field remains unaddressed. The desire to obfuscate TIDs is motivated by several factors. First, relevant studies and research have shown that TID values can leak behavioral and contextual information, even when other identifiers such as media access control (MAC) addresses are frequently rotated. The leakage occurs because TID values often maintain consistent associations with specific traffic types or application categories, allowing observers to infer usage patterns. Second, the TID field is only 4 bits in length and offers just 16 different values. The limited range makes conventional rotation-based anonymization less effective. Furthermore, unlike MAC addresses or association identifiers (AIDs), which typically involve a single identifier per STA per epoch, TID obfuscation should account for potentially all 16 TID values (0-15) used by a single STA during the same epoch. Third, certain traffic types, such as voice, can be identified with high confidence using only a few frames.

Embodiments of the present disclosure provide a method, system, and apparatus for TID obfuscation in wireless networks to improve user privacy by reducing the trackability of TID-based traffic patterns. In one embodiment, a TID transformation matrix is used to perform per-epoch TID mapping. The matrix is defined as a N×M structure, where N represents the number of real TID values (e.g., 16) and M corresponds to the number of epochs for which the mappings are precomputed. Each row in the matrix defines how a given TID is mapped across epochs. The matrix may be generated by an AP or a STA. In some embodiments, separate matrices may be used for UL and DL traffic to increase obfuscation. To reduce signaling overhead and memory requirements, the matrix delivery mechanism may apply compression techniques (e.g., permutation encoding) or limit the matrix to only actively used TIDs.

In another embodiment, algorithmic techniques are used to generate TID mappings without relying on explicit matrix transmission. In this embodiment, the TID transformation is derived from a cryptographically secure pseudo-random number generator (CSPRNG) or encryption function seeded with a shared key (or seed) between the AP and the STA. The key (or seed) may be established or provisioned during the STA's association process or during secure handshake procedures (e.g., 4-way handshake). The bitstream output from the generator or encryption engine is processed to yield a valid permutation of TID values for each epoch and provide one-to-one mappings without collisions. To prevent mapping conflicts, the bitstream may be shifted or reprocessed until a valid permutation is achieved. The algorithmic approaches allow both the AP and STA to independently compute identical TID mappings for each epoch, and therefore enable synchronization without requiring the transmission of the full matrix. In some embodiments, different seeds or functions are used to produce separate mappings for UL and DL traffic. In some embodiments, mappings are generated on demand for only the TIDs actively used by the STA, which reduces computational complexity and improves scalability.

In another embodiment, lightweight obfuscation mechanisms are introduced to provide efficient and frame-level TID anonymization. These techniques may be useful for obfuscating short traffic patterns, such as voice packets, that may be recognizable even within a single epoch. In some embodiments, a bitstream derived from a shared key (or seed) is segmented into 4-bit chunks. Each chunk is then XORed with the real TID to produce the over-the-air (OTA)-TID. The operation may be performed once per epoch or, in some configurations, at the frame level. In the per-frame approach, the specific bitstream chunk used for each frame is indexed based on metadata such as sequence number (SN) or packet number (PN), allowing each frame to carry a potentially unique OTA-TID. In some embodiments, the UL and DL traffic may use different seeds or transformation logic, which may further increase the variability and unpredictability of the observed TID values.

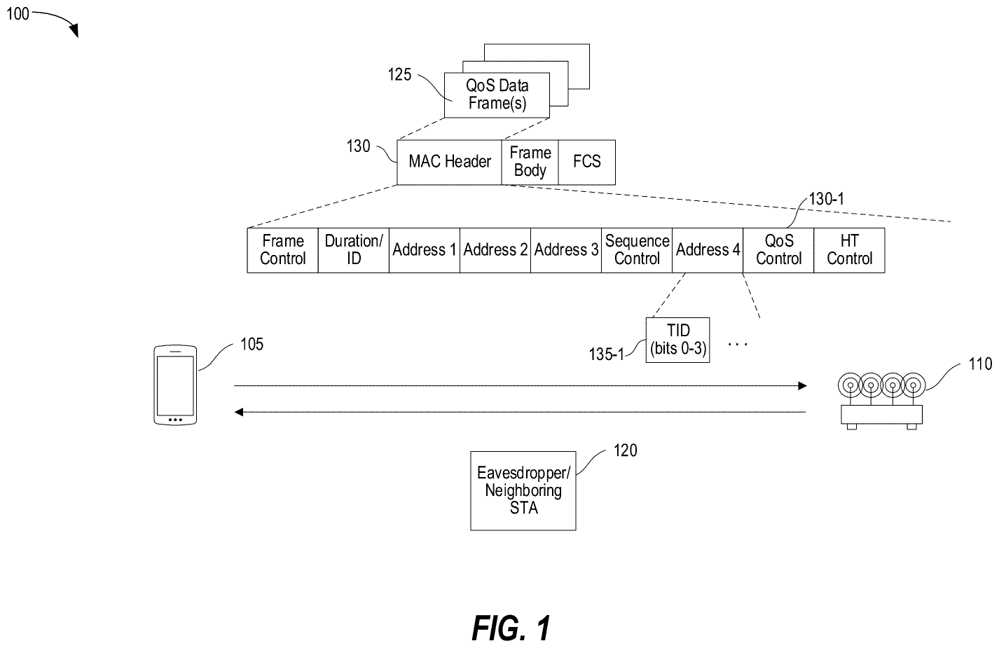

FIG. 1 depicts an example wireless environment 100 in which the disclosed TID obfuscation techniques may be implemented. The example environment 100 includes a station (STA) 105 and an access point (AP) 110, which exchange data frames 125 over a wireless medium in accordance with relevant standards (e.g., IEEE 802.11bi). The STA 105 may represent either a single-link station or a multi-link device (STA MLD). The AP 110 may correspond to either a single-link AP or a multi-link AP (AP MLD). The STA 105 and AP 110 are members of the same extended service set (ESS) and may establish communication over one or more links simultaneously, as supported in multi-link operation (MLO).

As depicted, the environment 100 also includes an observer device 120, which may represent an eavesdropper or a neighboring STA within the same ESS. The observer 120 may attempt to extract traffic-related patterns or behavioral information from the OTA transmissions.

As depicted, the STA 105 and AP 110 exchange data frames 125, which may flow in the UL and/or DL direction. As depicted, each data frame 125 includes a MAC header 130, which precedes the payload (frame body) and the Frame Check Sequence (FCS).

The MAC header 130 comprises multiple fields, including the Frame Control field, Duration/ID field, Address fields (Address 1, Address 2, Address 3), Sequence Control field, Address 4 field, Quality of Service (QoS) Control field, and HT Control field.

Within the QoS field 130-1, the first four bits (bit positions 0-3) encode the traffic identifier (TID). The TID is a 4-bit field 135-1 and allows for 16 possible values (0 through 15). TID values are used by the MAC layer to distinguish among different traffic categories, each mapped to a particular access category (AC) as defined by the enhanced distributed channel access (EDCA) mechanism.

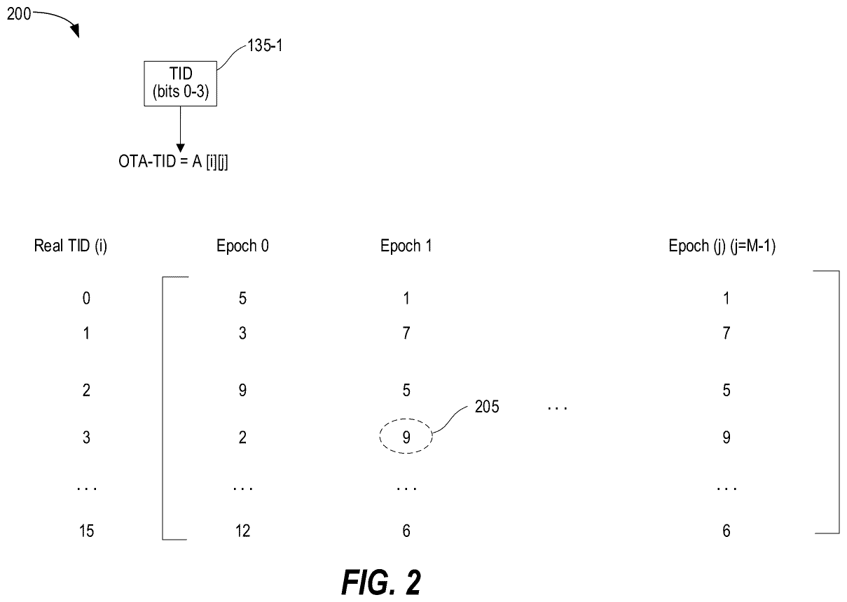

More specifically, TID values are used to differentiate traffic categories within the QoS framework. For example, TID values 0 and 2 correspond to best-effort or background traffic. Values 3 and 4 are assigned to video streams. Higher-priority traffic, such as voice, is mapped to TID values 5 and 6. TID 7 may be reserved for management or control frames, and values from 8 to 15 may be reserved or used for vendor-specific classifications depending on implementation. Because TID values often remain static over time and are closely tied to specific application behaviors, the observer device 120 intercepting QoS data frames 125 may analyze the TID field 135-1 to infer the type and priority of the underlying traffic. Given that the TID field 135-1 is only 4 bits and offers just 16 possible values, repeated patterns or frequency distribution may enable inference of application-level usage and, over time, even contribute to tracking a specific STA. Therefore, to improve privacy and minimize the risk of behavioral inference or device identification, it is desirable to implement TID obfuscation mechanisms that disrupt these patterns. Details about TID obfuscation are discussed below with references to FIGS. 2-6.

FIG. 2 depicts an example transformation matrix 200, as used in the matrix-based TID obfuscation. The matrix A (200) is a two-dimensional structure with 16 rows and M columns, where each row corresponds to one of the real TID values (i=0 to 15), and each column corresponds to a specific epoch (j=0 to M−1). Thus, the matrix entry A[i][j] represents the OTA-TID that the STA uses to transmit data originally associated with real TID i during epoch j. The relationship may be expressed as follows:

OTA-TID=A[i][j], where i is the real TID value, and j is the current epoch index.

In this embodiment, an AP (e.g., 110 of FIG. 1) generates the transformation matrix 200 for each STA (e.g., 105 of FIG. 1) at the time of association. The matrix may be generated randomly under the constraint that each column contains a permutation of the 16 TID values to provide one-to-one mappings and avoid collisions. Once generated, the matrix A is transmitted from the AP to the STA as part of the association response or in a suitable management frame.

During operation, the matrix enables symmetric and reversible TID mapping for both UL and DL traffic. When the STA transmits an UL data frame, the STA identifies the current real TID i (e.g., i=3) and the current epoch j (e.g., j=5), and uses the corresponding matrix entry to transform the TID field 135-1 in the QoS control header. In the depicted matrix 200, when real TID is 3 and the current epoch is Epoch 1, the OTA-TID is 9 (as depicted by 205) (e.g., A[3][1]).

The AP, upon receiving the frame, applies the inverse mapping or looks up the matrix to recover the original TID. The relationship may be expressed as follows:

$$Real TID = {A}^{- 1} [ OTA - TID ] [ j ] .$$

For DL transmissions, the AP selects the appropriate OTA-TID from the matrix for a given STA and epoch, and embeds the OTA-TID value into the outgoing frame. The STA, upon receiving the frame, references the same matrix to determine the real TID associated with the OTA-TID value.

The bidirectional matrix-based transformation process operates independently of the internal AC classification logic at both the STA and the AP. As defined in relevant standards, the MAC layer maps incoming frames to one of four ACs (voice, video, best effort, or background) based on the original TID value prior to any over-the-air transformation. Because the real TID remains intact within the device for scheduling, content handling, and queue management, the mapping to ACs and the operation of enhanced distributed channel access (EDCA) remain fully compliant with existing 802.11 QoS mechanisms. The OTA-TID substitution affects only the transmitted frame format and is reserved at the receiving entity.

To maintain obfuscation effectiveness over time, in some embodiments, the transformation matrix 200 may be periodically refreshed. The AP may generate and transmit a new matrix to the STA at regular intervals, with a sufficient time margin before the current matrix reaches the end of its M-epoch coverage.

In some embodiments, the transformation matrix 200 may be transmitted in a format where each entry is represented using a full 4-bit value. Since the matrix includes 16 TID values per epoch, and each epoch corresponds to a single column, this may lead to a size of 64 bits (8 bytes) per column. For a matrix that spans 300 epochs (e.g., M=300), the total size would be 19,200 bits or 2400 bytes. The uncompressed version offers straightforward implementation and fast lookup performance at the cost of moderate transmission size. Given the data rate and infrequent update interval (e.g., once per several seconds or minutes), such a payload may be delivered via a single management or action frame.

In some embodiments, to reduce transmission overhead, a compressed representation of the matrix 200 may be used. In these embodiments, each column of the matrix is a permutation of the 16 TID values, which eliminates the need to explicitly transmit all 16 values. Instead, the AP may encode each permutation using a compact representation. For example, a full permutation of 16 elements can be described using approximately 44 bits (log₂(16!)≈44). The compressed representation reduces the per-epoch payload from 64 bits to 44 bits and provides substantial bandwidth savings (up to 31% compared to the uncompressed form). For 300 epochs, the total transmission size drops from 2400 bytes to approximately 1650 bytes, which enables more efficient control messaging and lower airtime usage.

In some embodiments, the STA (e.g., 105 of FIG. 1) may generate the TID transformation matrix 200 and transmit it to the AP (e.g., 110 of FIG. 1). This approach may be useful in cases where STAs are pre-configured with local obfuscation logic or when privacy policies mandate that clients control their own identifier anonymization strategies. In this configuration, the STA computes a 16×M matrix in the same structure as depicted in FIG. 2, with each row corresponding to a real TID and each column to an epoch. The matrix may be generated randomly or derived from a transformation algorithm using a local seed. Once generated, the STA transmits the matrix to the AP during the association phase (e.g., via a (re) association request) or through a secure signaling message. The matrix may be sent in either uncompressed or compressed form, similar to the AP-generated version. During operation, the STA applies the matrix to transform real TIDs into OTA-TIDs when transmitting uplink data. The AP, having previously received the matrix, may then map the OTA-TID back to the original TID for proper classification and QoS treatment. For DL traffic, the AP uses the received matrix to determine the correct OTA-TID for each frame destined for the STA.

In some embodiments, to increase the complexity of the obfuscation, different mappings are used for uplink and downlink traffic. In these configurations, the STA and AP may independently generate and exchange separate transformation matrices for UL and DL traffic, respectively. For example, the STA generates a TID transformation matrix for UL frames and transmits it to the AP during association or via secure signaling. The UL matrix allows the STA to anonymize the real TID for each UL data frame. The AP generates a separate DL matrix that is sent to the STA. The AP uses the DL matrix to determine the appropriate OTA-TID for DL frames, and the STA uses the shared DL matrix to identify the real TID upon reception. The bidirectional mapping scheme further improves privacy protection, as the real TID-to-OTA-TID mapping is no longer symmetric between UL and DL. More specifically, the same real TID value may be mapping to entirely different OTA-TIDs in the UL and DL directions during the same epoch. As a result, even if an observer (e.g., 120 of FIG. 1) is able to correlate patterns in one traffic direction (e.g., UL traffic), those insights cannot be used to decode or link traffic in the opposite direction (e.g., DL traffic).

In some embodiments, a sparse or on-demand mapping strategy may be used to further optimize storage, signaling, and computational efficiency. A STA typically does not use all 16 TID values concurrently during any given epoch, and therefore many TIDs remain inactive. To reduce overhead, the transformation matrix is generated and maintained for active TIDs (e.g., those that are currently in use or anticipated for upcoming traffic flows). During the association phase, or at any point when a new TID is first invoked, the STA may request a TID mapping specifically for that TID. The request may include an indication of the TID that the STA expects to use over a sequence of upcoming epochs. The AP responds by allocating an OTA-TID mapping for the requested TID and may update the sparse transformation matrix accordingly. The mapping may be computed directly or drawn from a pre-established matrix structure. The same procedure applies if the AP initiates a mapping for downlink traffic. When a particular TID is no longer needed, for example, when the associated application terminates or the traffic flow ends, the mapping for that TID may be retired or deactivated. This may be achieved either via explicit signaling from the STA to the AP indicating deactivation or implicitly by halting updates for that TID in future epoch refreshes. As a result, the transformation matrix becomes sparse and stores only the relevant rows for currently active TIDs, and the signaling overhead for full matrix distribution is avoided.

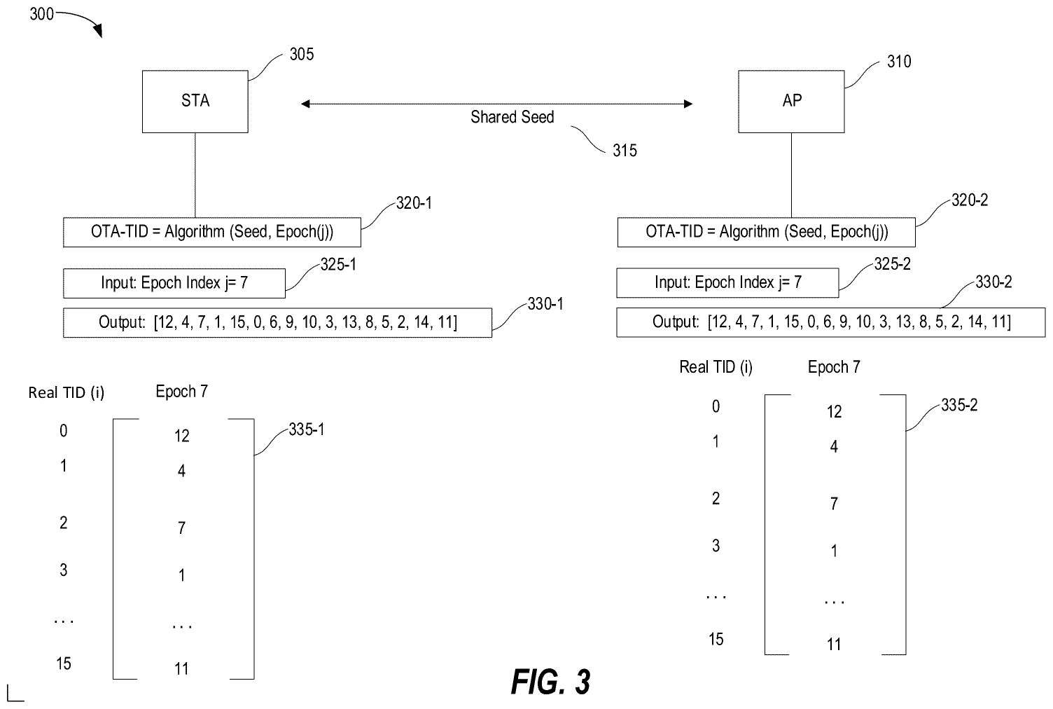

FIG. 3 depicts an example algorithmic TID obfuscation procedure 300 using a shared seed between a STA 305 and an AP 310. The STA 305 may correspond to the STA 105 as depicted in FIG. 1, and the AP 310 may correspond to the AP 110 as depicted in FIG. 1. In this embodiment, instead of relying on a pre-transmitted matrix, the STA and AP both independently generate TID transformations on a per-epoch basis using a shared seed (or key) 315 and a cryptographic algorithm.

During the association phase or secure handshake process, the STA 305 and AP 310 establish a shared seed (e.g., a cryptographic key or seed). For each epoch j, both entities use the shared seed to generate the real TID-to-OTA-TID mapping via a cryptographic algorithm. The TID obfuscation process may be represented as follows:

$$OTA - TID = Algorithm ( Speed , Epoch ( j ) ) ( as depicted by 320 - 1 ) .$$

The algorithm used to generate TID mappings may be a cryptographic encryption function or a CSPRNG. In embodiments where a cryptographic encryption function such as advanced encryption standard (AES) is used, the epoch index is used as input, and the output is a pseudo-random block of data. The block may be produced using standard cipher modes (e.g., counter (CTR) mode) or cipher block chaining with message authentication (CBC-MAC). In embodiments when the CSPRNG is used, a per-epoch seed is derived by applying a keyed hash function, such as HMAC, over the shared seed and the epoch index (e.g., Seed(j)=HMAC (Seed, Epoch(j)). The derived seed initializes the CSPRNG, which then outputs a bitstream from which a valid permutation of TID values is constructed.

For example, as depicted, the epoch index is 7 (as depicted by 325-1), the STA computes Seed(7)=HMAC (Seed, 7). The per-epoch seed is then used to initialize a CSPRNG, which outputs the following sequence of OTA-TID values for epoch 7: [12, 4, 7, 1, 15, 0, 6, 9, 10, 3, 13, 8, 5, 2, 14, 11] (as depicted by 330-1). The list 330-1 defines a mapping of the 16 real TID values to their corresponding OTA-TID values for epoch 7. For example, real TID 0 is mapped to OTA-TID 12, real TID 1 is mapped to OTA-TID 4, and so on. The output 330-1 constitutes column “Epoch 7” 335-1 within a 16×M transformation matrix saved by the STA 305, with each column generated as needed.

As depicted, the AP 310 executes the same cryptographic algorithm 320-2 used by the STA 305 to generate TID mapping for each epoch. The AP 310 inputs the same shared seed 315 and epoch index 325-2 as the STA (e.g., epoch index 7) (as depicted by 325-2) to compute the corresponding OTA-TID permutation. In this configuration, the algorithm produces the following sequence: [12, 4, 7, 1, 15, 0, 6, 9, 10, 3, 13, 8, 5, 2, 14, 11] (as depicted by 330-2). The list constitutes column “Epoch 7” 335-2 of the logical transformation matrix stored in the AP's memory. Because both entities derive the mapping locally, it does not require the STA or AP to transmit any matrix information over the air. This algorithmic TID obfuscation approach reduces protocol overhead and improves efficiency.

To ensure that the generated outputs 330 form a valid permutation of the 16 possible TID values (e.g., each OTA-TID is unique per epoch), the AP 310 or STA 305 may include a conflict resolution mechanism within the algorithm. Since the output of a PRNG or encryption function may not always generate a collision-free sequence, the AP or STA may verify that no duplicate OTA-TID values appear in the computed list. If a conflict is detected, such as two real TIDs mapping to the same OTA-TID within a given epoch, the AP or STA adjusts the algorithm. This may involve shifting the bitstream by one or more bits or modifying the seed input, and rerunning the generation until a valid one-to-one mapping is produced.

The algorithmic TID obfuscation may be applied to both DL and UL traffic. For UL transmission, the STA 305 uses the current epoch index to compute the OTA-TID corresponding to the real TID of the UL data frame. Upon reception, the AP 310 performs the same computation to identify the original TID and correctly classify the traffic. For DL traffic, the AP 310 applies the algorithm to determine the OTA-TID to be embedded in each frame based on the intended real TID and epoch. The STA, upon receiving the frame, uses the shared seed, epoch index, and the OTA-TID to recover the original traffic classification.

In some embodiments, the algorithmic TID obfuscation may be applied on an on-demand and per-TID basis, instead of generating a full permutation of all 16 TIDs for every epoch. The on-demand approach reduces computational complexity and memory requirements, particularly in scenarios where only a subset of TIDs is active at any given time. In these embodiments, the OTA-TID is computed dynamically using a function that takes into account not only the shared seed and epoch index but also the specific real TID to be obfuscated. The transformation is defined as follows:

$$OTA - TID = Algorithm ( Speed , Epoch ( j ) , Real TID ( i ) ) .$$

For example, when the STA 305 is transmitting a QoS data frame during epoch 7 with real TID 5, it invokes the algorithm as Algorithm (seed, 7, 5) and obtains OTA-TID as 15. The value 15 is then placed into the QoS control field (e.g., 130-1 of FIG. 1) of the frame. Upon receiving the frame, the AP 310 extracts both the OTA-TID and the epoch index (either explicitly signaled or inferred from timing) and recomputes the expected OTA-TID values for all possible real TIDs for that epoch using the same function and seed. Once it finds a match (e.g., Algorithm (seed, 7, 5)=15), the AP 310 identifies the corresponding real TID 5 and processes the frame accordingly. The same process applies in the DL direction. The AP 310 uses the real TID associated with the frame and computes the OTA-TID using the algorithm and the current epoch index. The STA 305, upon receiving the DL frame, performs the computation and identifies a matching real TID.

The on-demand TID obfuscation mechanism avoids generating and storing a full 16-entry transformation table at the sending entity (the STA 305 in the UL direction or the AP 310 in the DL direction). Instead, the sender computes the OTA-TID dynamically for each transmitted frame using the real TID and current epoch index. This approach reduces computational and memory overhead on the transmitting side. On the receiving side, however, the full mapping may still be performed. The receiver uses the shared seed and epoch index to compute the algorithm output for all 16 possible real TID values, and compares each result to the received OTA-TID until the correct match is found.

In some embodiments, different seeds may be used to generate distinct mappings for each traffic direction during the same epoch. For example, a UL seed is used to generate a TID mapping for UL traffic, and a DL seed is used for DL traffic. This results in non-correlated OTA-TID mappings for UL and DL traffic, even when the real TID and epoch index are identical For example, during epoch 7, real TID 5 may map to OTA-TID 15 in the UL direction but to OTA-TID 3 in the DL direction. As a result, an external observer cannot infer traffic type or behavior by correlating OTA-TIDs across directions.

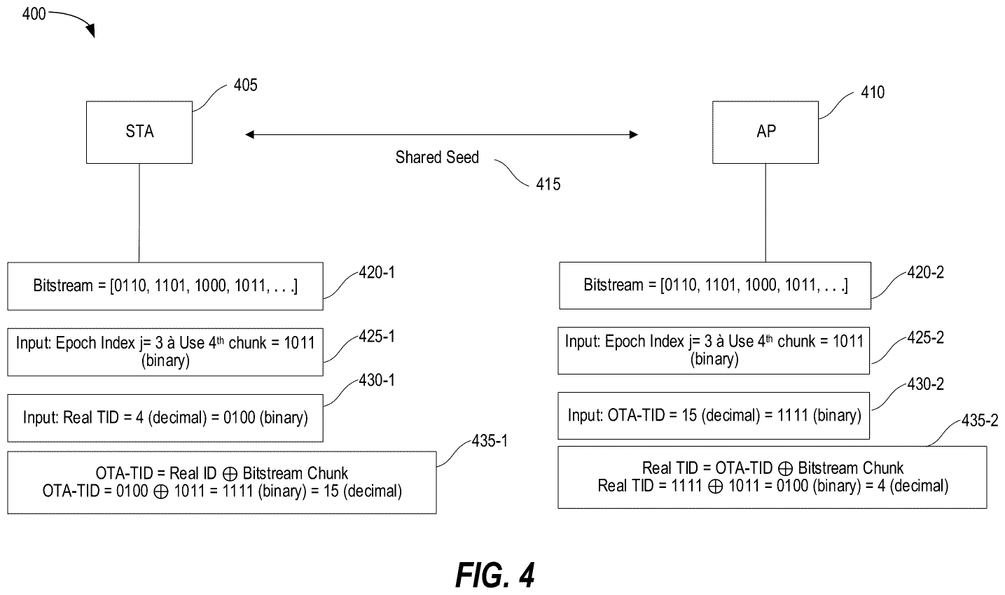

FIG. 4 depicts an example XOR-based TID obfuscation process 400 between a STA 405 and an AP 410. The STA 305 may correspond to the STA 105 as depicted in FIG. 1, and the AP 310 may correspond to the AP 110 as depicted in FIG. 1. The XOR-based obfuscation scheme uses a shared bitstream derived from a common seed established during the association or handshake phase.

As depicted, the STA 405 and AP 410 both generate an identical bitstream (as depicted by 420-1 and 420-2), where each 4-bit chunk corresponds to one epoch. An example bitstream includes: [0110, 1101, 1000, 1011, . . . ]. The bitstream is generated from a shared seed 415 using a cryptographically secure function (e.g., CSPRNG).

To compute the OTA-TID, as depicted, the STA 405 takes the real TID, represented in 4-bit binary format (as depicted by 430-1), and performs a bitwise XOR operation with the chunk of the bitstream associated with the current epoch (as depicted by 425-1). The TID obfuscation process may be expressed as follows:

$$OTA - TID = Real ID ⊕ Bitstream Chunk .$$

For example, if the epoch index is 3, the STA uses the 4th chunk, which is 1011. If the real TID is 4 (e.g., binary 0100), the computation proceeds as follows:

OTA-TID=0100 @ 1011=1111, which is decimal 15.

The resulting OTA-TID value (as depicted by 435-1) is placed in the QoS control field of the frame.

Upon receiving the frame, the AP 410 performs the reverse operation to recover the real TID, represented as follows:

$$Real TID = OTA - TID ⊕ Bitstream Chunk .$$

Using the same epoch index 3 (as depicted by 425-2) and the received OTA-TID 15 (as depicted by 430-2), the reverse computation proceeds as follows:

Real TID=1111 ⊕1011=0100, which is decimal 4 (as depicted by 435-2).

This embodiment introduces a lightweight and computationally efficient approach for TID obfuscation. The XOR-based approach is suitable for environments where full permutation-based mapping may be too heavy, but some degree of privacy protection is still desired (or needed). The XOR-based approach supports symmetric usage in both UL and DL directions. FIG. 4 depicts the UL scenario, where the STA computes the OTA-TID by XORing the real TID with the bitstream chunk corresponding to the current epoch and sends the resulting OTA-TID in the data frame to the AP. In the DL scenario, the process is mirrored where the AP computes the OTA-TID by applying the XOR operation between the real TID and the relevant bitstream chunk, and includes it in the transmitted frame. Upon reception, the STA uses the same bitstream chunk and XORs it with the OTA-TID to recover the real TID.

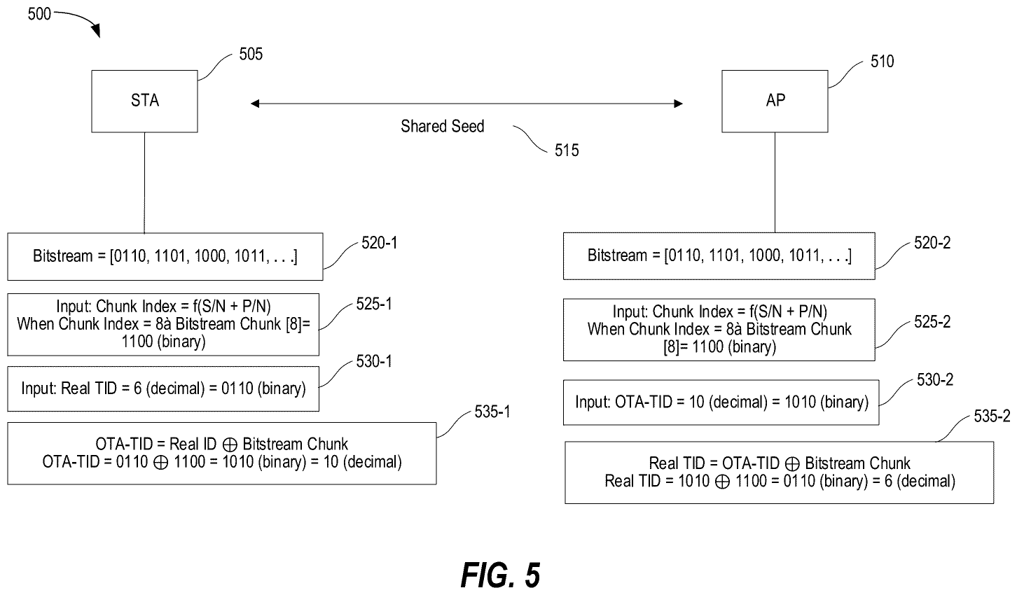

FIG. 5 depicts an example per-frame XOR-based TID obfuscation process 500 between a STA 505 and an AP 510. The STA 505 may correspond to the STA 105 as depicted in FIG. 1, and the AP 510 may correspond to the AP 110 as depicted in FIG. 1. The per-frame TID obfuscation is designed to further anonymize traffic patterns, practically for applications such as voice, where a small number of short, high-frequency frames may reveal identifiable behavioral signatures even within a single epoch.

To increase obfuscation granularity, the disclosed embodiment applies the XOR transformation at the frame level. A unique 4-bit chunk from the bitstream is used for each individual frame, allowing for the TID mappings to change on a per-frame basis.

As depicted, both the STA 505 and AP 510 derive an identical bitstream (as depicted by 520-1 and 520-2) using a shared cryptographic seed 515. The bitstream is segmented into 4-bit chunks, with each chunk corresponding to a single transmitted frame. These 4-bit segments are then used as XOR masks for TID obfuscation. An example bitstream includes: [0110, 1101, 1000, 1011, . . . ].

To determine which 4-bit chunk to use for a given frame, both the STA and AP calculate a chunk index based on frame-specific metadata (as depicted by 525-1 and 525-2). In one embodiment, the index is computed as a function of the sequence number (S/N) and the packet number (P/N). The chunk index calculation process may be expressed as follows:

$$Chunk Index = f ( S / N , P / N ) ( as depicted by 525 - 1 and 525 - 2 ) .$$

In one embodiment, the chunk index is calculated as follows:

Chunk Index=(S/N+P/N) mod N, where N is the number of available 4-bit chunks in the bitstream.

As depicted in FIG. 5, when the computed chunk index is 8, the corresponding bitstream chunk “1100” is identified. If the STA 505 is preparing to send a data frame in the UL direction with a real TID of 6 (binary 0110) (as depicted by 530-1), the STA applies the XOR transformation: OTA-TID=0110 @ 1100=1010, which is decimal 10 (as depicted by 535-1). The value 10 is inserted into the QoS control field of the data frame.

On the receiving side, the AP 510 extracts the same frame metadata (e.g., S/N and P/N), uses the same function to derive chunk index 8, and retrieves the bitstream chunk “1100” from its locally generated bitstream (as depicted by 525-2). The AP 510 then uses the extracted OTA-TID (as depicted by 530-2) to reverse the transformation: Real TID=1010 @ 1100=0110, which is decimal 6 (as depicted by 535-2).

The per-frame TID obfuscation approach also applies to DL traffic, where the AP 510 computes the OTA-TID per frame and the STA performs the reverse operation. This embodiment provides improved privacy protection, particularly for traffic flows such as voice and video.

In some embodiments, separate seeds or stream generation processes are applied to UL and DL traffic. With the per-direction XOR masks, the same real TID may map to different OTA-TID values in the UL and DL directions, even within the same epoch or frame index. This approach enhances privacy by preventing cross-directional correlation of OTA-TIDs, making it more difficult for observers to link related traffic flows.

The example method 500 applies to a per-TID basis, assuming that packets associated with each TID are transmitted in the same order in which they are received. This allows the sender and receiver to derive a common chunk index (e.g., based on sequence number or packet number) for each frame, and therefore enables consistent per-frame XOR transformation. However, to support global application, such as applying the method uniformly across all packets, a separate and independent bitstream may be maintained for each TID. In this configuration, the STA and AP may generate and track different bitstreams per TID.

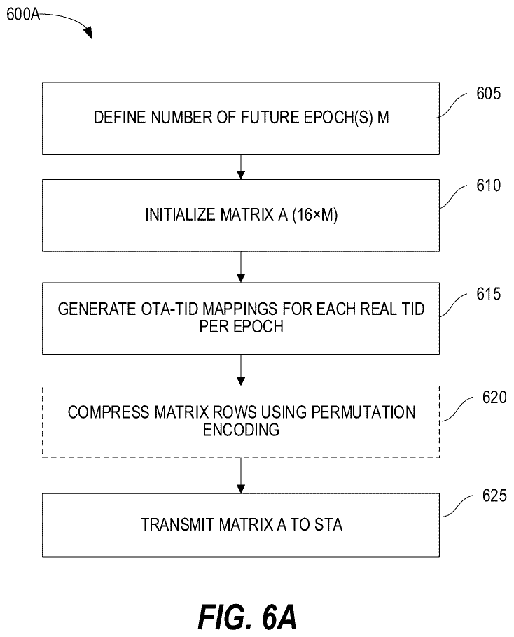

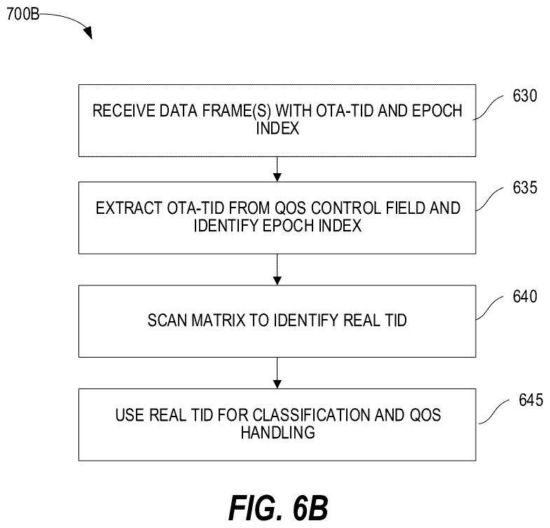

FIG. 6A depicts an example method 600A for generating and distributing a TID transformation matrix, according to some embodiments of the present disclosure. The example method 600A may be performed by an AP, such as the AP 110 as depicted in FIG. 1, or any other network device capable of managing and distributing TID obfuscation mappings.

At block 605, an AP (e.g., 110 of FIG. 1) defines the number of future epochs M for which TID transformations will be computed. The epoch length may be defined by policy or dynamically based on network configuration.

At block 610, the AP initializes a transformation matrix A (e.g., 200 of FIG. 2), structured as a 16×M format. Each row corresponds to one of the 16 possible real TID values (0-15), and each column represents a specific epoch index ranging from 0 to M−1.

At block 615, the AP generates OTA-TID mappings for each real TID across all epochs and populates each entry of the matrix with the corresponding OTA-TID value. In some embodiments, the AP performs a conflict check to ensure that each column of the matrix represents a valid one-to-one mapping (e.g., no duplicate OTA-TID values are assigned to different real TIDs within the same epoch).

At block 620, the AP applies compression to the matrix before transmission. Since each column is a permutation of the 16 known TID values, the column may be encoded compactly using permutation encoding, which requires approximately 44 bits (log₂(16!)≈44). The compression reduces bandwidth consumption during signaling, and may be applied when efficient OTA transmission is desired, such as in dense deployments or low-bandwidth environments.

At block 625, the AP transmits the matrix A, either in its compressed or uncompressed form, to the target STA (e.g., 105 of FIG. 1). The transmission may occur during the association phase, reassociation, or as part of a periodic refresh process triggered before the current matrix expires (e.g., before the M epochs have elapsed). The STA stores the matrix and uses it to map real TID values to OTA-TIDs for each epoch during UL transmission and to decode OTA-TIDs received in DL frames.

Although FIG. 6A focuses on the AP-side generation and delivery of the transformation matrix, in some embodiments, the matrix may instead be generated by the STA and shared with the AP. In this configuration, the STA constructs the 16×M matrix (optionally compressed) and transmits it during association or secure handshake phase. The mechanism allows the STA to control the obfuscation logic and may be preferred in scenarios where client-driven privacy is desired.

In some embodiments, separate matrices may be generated for UL and DL directions to further increase obfuscation complexity. For example, the STA may provide a matrix for uplink traffic, and the AP may provide a separate matrix for DL use.

In some embodiments, the transformation matrix may be generated on demand for active TIDs only. Instead of populating all 16 rows, the AP or STA may generate and maintain mappings only for the subset of TIDs currently in use. The sparse and on-demand matrix approach reduces computation, storage, and signaling overhead, such as when a device uses only a few TID values at a time. Additional mappings may be created dynamically when new TIDs become active, and removed or expired when no longer needed.

FIG. 6B depicts an example method 600B for resolving a real TID from a received OTA-TID using a TID transformation matrix, according to some embodiments of the present disclosure. The example method 600B occurs after the transformation matrix has already been generated and shared, either by the AP itself (as shown in FIG. 6A) or by the STA. The method 600B applies to UL scenarios, where the STA obfuscates its real TID before transmission.

At block 630, the AP receives one or more QoS data frames from the STA. The frame includes an OTA-TID in the QoS Control field (e.g., 130-1 of FIG. 1). Each of the frames may include an explicit epoch index, or the epoch may be inferred based on timing. Prior to transmission, the STA used the current epoch index and the shared matrix to locate the corresponding OTA-TID value for its real TID (e.g., OTA-TID=A[i][j], where i represents real TID and j represents epoch index).

At block 635, the AP extracts the OTA-TID from the received frame's QoS Control field and identifies the epoch index (e.g., either from metadata included in the frame or derived based on the current system time synchronized with the STA).

At block 640, the AP performs a lookup in the transformation matrix, which involves scanning the column of the matrix corresponding to the received epoch index and locating the row where the OTA-TID matches the received value. The row index identifies the original real TID used by the STA.

At block 645, the recovered real TID is used for MAC layer classification and QoS handling.

FIG. 6B focuses on the UL case where the AP uses the matrix to recover the real TID from a received frame. In the DL scenario, the AP uses the same transformation matrix in the forward direction. Specifically, before transmitting a QoS data frame to the STA, the AP identifies the real TID associated with the traffic and the current epoch index, and then looks up the corresponding OTA-TID from the matrix (e.g., using OTA-TID=A[i][j]). The OTA-TID is inserted into the QoS Control field of the transmitted frame. Upon receiving the frame, the STA uses the same matrix to perform the reverse mapping and recover the original TID.

In embodiments where the STA generates the transformation matrix, the example method 600B may include an additional step of receiving the matrix from the STA. The reception may occur during association or via explicit signaling. The AP stores the received matrix and uses it to perform TID reverse mapping for UL traffic as described.

In embodiments with direction-specific mappings, the UL and DL matrices are generated independently. For example, the STA may provide the AP with a UL-specific matrix, and the AP may provide the STA with a DL-specific matrix. In such configurations, the method 600B may include a step where the AP receives the UL-specific transformation matrix from the STA and uses it exclusively for interpreting OTA-TIDs in UL frames.

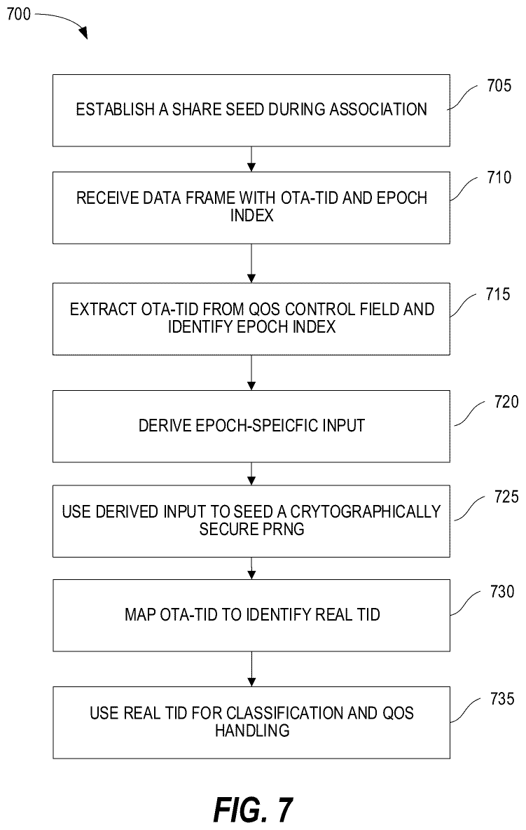

FIG. 7 depicts an example method 700 for resolving a real TID from a received OTA-TID using algorithmic mapping based on a shared seed, according to some embodiments of the present disclosure. The example method 700 may be performed by an AP, such as the AP 110 as depicted in FIG. 1, the AP 310 as depicted in FIG. 3, or any other network device capable of managing TID obfuscation mappings. The method 700 avoids explicit matrix exchange by enabling both the STA and AP to independently compute per-epoch TID mappings from a shared cryptographic seed. The method 700 is shown from the AP's perspective and applies to UL scenarios, where the STA has used the algorithm to generate and transmit an obfuscated TID value.

At block 705, an AP (e.g., 310 of FIG. 3) establishes a shared seed (or key) with a STA (e.g., 305 of FIG. 3) during the association or handshake phase. The seed (or key) (e.g., 315 of FIG. 3) is used as the common basis for deriving synchronized TID transformation logic over time.

At block 710, the AP receives one or more data frames from the STA. Each frame includes an OTA-TID in the QoS Control field. The frame may also carry an explicit epoch index, or the AP may infer it based on the frame's arrival time and previously established epoch structure.

Prior to transmission, the STA generated the OTA-TID using its own real TID and the current epoch index. Specifically, the STA derived an epoch-specific input (e.g., HMAC(seed, epoch)) and seeded a CSPRNG or encryption-based function to generate a permutation of the 16 possible TID values. The STA then selected the OTA-TID as the entry in the permutation corresponding to its real TID.

At block 715, the AP extracts the OTA-TID from the frame and identifies the epoch index associated with the transmission.

At block 720, the AP derives an epoch-specific input using the shared seed and the identified epoch index (e.g., HMAC(seed, epoch)).

At block 725, the derived epoch-specific input is used to seed a cryptographic function or CSPRNG, which outputs a 16-value permutation of the TID space (e.g., a logical column of a virtual transformation matrix for that epoch).

At block 730, the AP locates the real TID by scanning the permutation output and finding the position i such that permutation[i] is equal to the received OTA-TID (e.g., Permutation[i]=OTA-TID). The index i is the original real TID used by the STA.

At block 735, the AP uses the recovered real TID for internal classification and QoS handling in accordance with MAC-layer rules and EDCA logic.

While the example method 700 focuses on the UL case, the same algorithmic obfuscation approach applies to DL traffic. In the DL scenario, the AP, now acting as the transmitting device, uses the same procedure to compute the OTA-TID before transmission. Upon reception, the STA performs the same algorithmic calculation to recover the real TID for classification.

In some embodiments, the transmitting device (whether STA or AP) may not need to compute the entire TID permutation for a given epoch. Instead, the transmitting device may calculate only the single OTA-TID value corresponding to the real TID it needs to send, reducing computation time and memory usage. On the other hand, the receiving device may still compute the full permutation to perform reverse mapping, to locate the real TID corresponding to the received OTA-TID. The on-demand obfuscation is advantageous for reducing overall system overhead, particularly where only a few TIDs are active.

In some embodiments, different seeds may be assigned to UL and DL directions to produce non-correlative TID mappings, even within the same epoch. In such configurations, at block 720, the AP uses the UL-specific seed to derive the epoch-specific input used to seed the PRNG or cryptographic function for recovering the TID permutation in the UL case. In the DL scenario, the AP instead uses the DL-specific seed to perform the same derivation process.

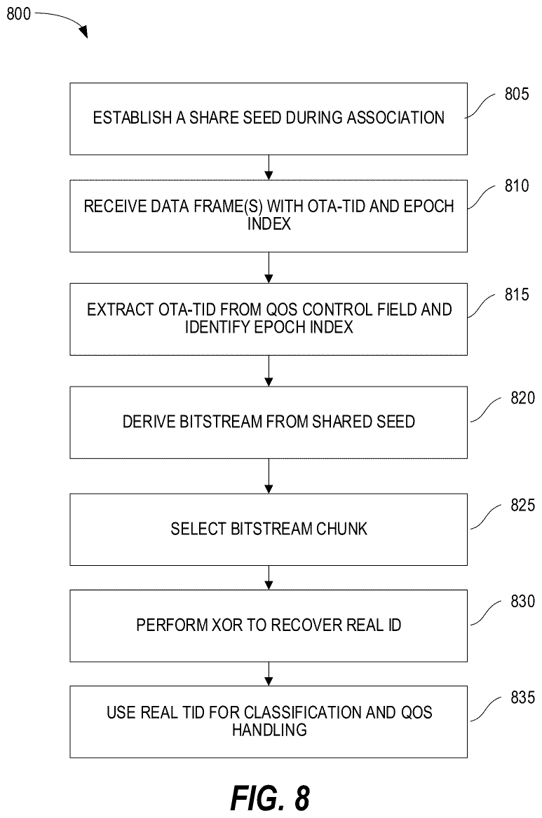

FIG. 8 depicts an example method 800 for resolving a real TID from a received OTA-TID using XOR-based obfuscation and a shared bitstream, according to some embodiments of the present disclosure. The example method 800 may be performed by an AP, such as the AP 110 as depicted in FIG. 1, the AP 410 as depicted in FIG. 4, the AP 510 as depicted in FIG. 5, or any other network device capable of managing TID obfuscation mappings. This embodiment provides a lightweight TID obfuscation scheme, which supports independent TID transformation without requiring matrix generation or exchange. The method 800 is shown from the AP's perspective and applies to UL scenarios, where the STA has applied an XOR-based transformation to generate and transmit an obfuscated TID value.

At block 805, an AP (e.g., 410 of FIG. 4) establishes a shared seed (or key) (e.g., 415 of FIG. 4) with a STA (e.g., 405 of FIG. 4) during the association or handshake phase. The seed (or key) serves as the common basis for generating a synchronized bitstream on both devices.

At block 810, the AP receives one or more data frames from the STA. Each frame includes an OTA-TID in the QoS Control field, along with an associated epoch index, either explicitly signaled or inferred from frame arrival time.

Prior to transmission, the STA generated the OTA-TID by first deriving the same bitstream from the shared seed. The STA then selected the 4-bit chunk corresponding to the current epoch index, and applied a bitwise XOR operation between its real TID and the selected chunk (e.g., OTA-TID=Real TID XOR Bitstream Chunk). The obfuscated value was inserted into the frame and transmitted to the AP.

At block 815, the AP extracts the OTA-TID from the frame's QoS Control field and identifies the corresponding epoch index.

At block 820, the AP uses the shared seed to derive a bitstream (e.g., 420-2 of FIG. 4), using a CSPRNG or hash-based function seeded with the shared key. The bitstream is identical to that used by the STA.

At block 825, the AP selects the 4-bit chunk from the bitstream corresponding to the received epoch index (e.g., Bitstream Chunk=Bitstream [j]). Each chunk serves as a mark for that epoch and is used in XOR operations.

At block 830, the AP performs a bitwise XOR operation between the received OTA-TID and the selected bitstream chunk to recover the real TID (e.g., Real TID=OTA-TID XOR Bitstream Chunk).

At block 835, the recovered real TID is used for MAC-layer classification and QoS handling. Because the mapping is symmetric and derived from a shared seed, the AP can accurately decode obfuscated TIDs without the need for any matrix synchronization or signaling overhead.

The example method enables lightweight TID obfuscation for privacy enhancement. Although the example method 800 focuses on the UL scenarios, the same XOR-based obfuscation approach applies to DL direction as well. In the DL case, the AP performs the same set of operations, using the shared seed to derive the bitstream, selecting the 4-bit chunk corresponding to the current epoch, and performing a bitwise XOR operation to compute OTA TID. Upon receiving the frame, the STA uses the same epoch index and bitstream chunk to reverse the operation and recover the real TID.

In some embodiments, different seeds may be assigned to UL and DL directions. For example, separate seeds may be used to generate distinct bitstreams for each direction and produce different OTA-TID values in UL and DL paths, even when the epoch index is the same. Direction-specific seed separation further improves privacy by preventing observers from correlating bidirectional traffic based on shared TID transformations.

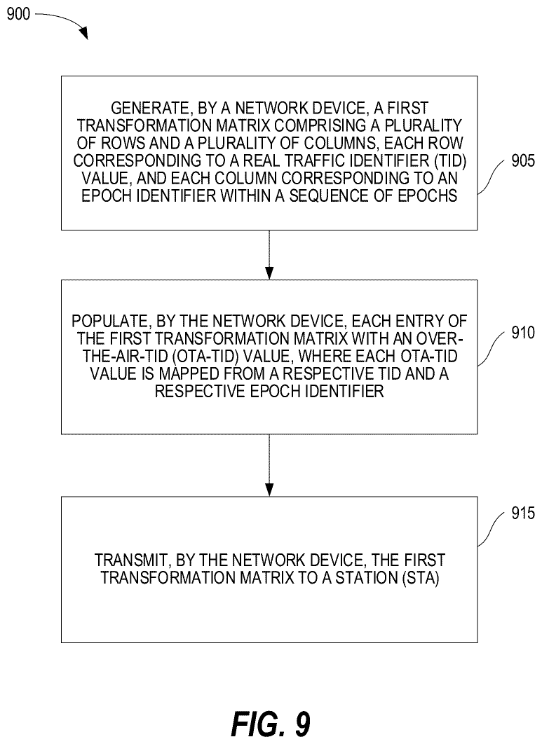

FIG. 9 is a block diagram depicting a method 900 for TID transformation matrix generation, according to some embodiments of the present disclosure.

At block 905, a network device (e.g., 110 of FIG. 1) generates a first transformation matrix (e.g., 200 of FIG. 2) comprising a plurality of rows and a plurality of columns, each row corresponding to a real traffic identifier (TID) value, and each column corresponding to an epoch identifier within a sequence of epochs.

At block 910, the network device populates each entry of the first transformation matrix with an over-the-air-TID (OTA-TID) value, where each OTA-TID value is mapped from a respective TID and a respective epoch identifier.

At block 915, the network device transmits the first transformation matrix to a station (STA) (e.g., 105 of FIG. 1).

In some embodiments, the network device may receive a data frame (e.g., 125 of FIG. 1) from the STA, the data frame comprising a first OTA-TID value selected by the STA based on the transformation matrix. The network device may recover a real TID value corresponding to the first OTA-TID value based on a respective epoch identifier associated with the data frame.

In some embodiments, the network device may update the first transformation matrix at a defined periodic interval, prior to expiration of the sequence of epochs represented in the transformation matrix.

In some embodiments, the network device may receive a second transformation matrix from the STA, the second transformation matrix being generated by the STA, where the second transformation matrix comprises a plurality of rows and a plurality of columns, each row corresponding to the real TID value, and each column corresponding to an epoch identifier within a sequence of next epochs that is different from the sequence of epochs represented in the first transformation matrix generated by the network device.

In some embodiments, the first transformation matrix generated by the network device may be used to obfuscate real TIDs for downlink traffic transmitted from the network device to the STA, and the second transformation matrix generated by the STA may be used to obfuscate real TIDs for uplink traffic transmitted from the STA to the network device.

In some embodiments, the network device may comprise at least one of an access point (AP), a wireless controller, a gateway device, or a cloud-based server.

In some embodiments, the network device may generate the first transformation matrix in response to receiving a request from the STA, the request comprising one or more real TID values that the STA expects to use during the sequence of epochs, and within the first transformation matrix, each row corresponds to one of the TID values indicated in the request, and each column corresponds to an epoch identifier within the sequence of epochs.

In some embodiments, the network device may transmit a data frame to the STA, the data frame comprising a first OTA-TID value selected by the network device based on the transformation matrix, where the STA recovers a real TID value corresponding to the first OTA-TID value based on a respective epoch identifier associated with the data frame.

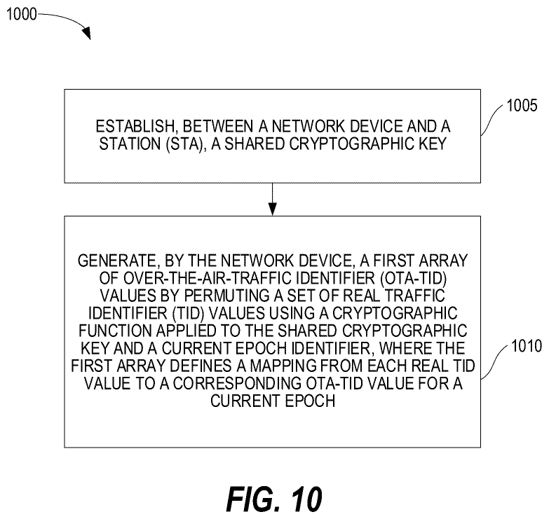

FIG. 10 is a block diagram depicting a method 1000 for TID permutation array generation, according to some embodiments of the present disclosure.

At block 1005, a network device (e.g., 310 of FIG. 3) establishes a shared cryptographic key (e.g., 315 of FIG. 3) between the network device and a station (STA) (e.g., 305 of FIG. 3).

At block 1010, the network device generates a first array of over-the-air-traffic identifier (OTA-TID) values (e.g., 330-2 of FIG. 3) by permuting a set of real traffic identifier (TID) values using a cryptographic function applied to the shared cryptographic key and a current epoch identifier (e.g., 325-2 of FIG. 3), where the first array defines a mapping (e.g., 335-2 of FIG. 3) from each real TID value to a corresponding OTA-TID value for a current epoch.

In some embodiments, the STA may generate a second array of OTA-TID values (e.g., 330-1 of FIG. 3) by permuting the set of real TID values using the cryptographic function applied to the shared cryptographic key and the current epoch identifier (e.g., 325-1 of FIG. 3), and the second array is identical to the first array.

In some embodiments, the network device may receive, from the STA, a data frame comprising a first OTA-TID selected by the STA based on the second array, and recover a real TID corresponding to the first OTA-TID value using the first array and the current epoch identifier.

In some embodiments, the network device may transmit a data frame to the STA, the data frame comprising a first OTA-TID value selected by the network device based on the first array, where the STA recovers a real TID value corresponding to the first OTA-TID value using the second array and the current epoch identifier.

In some embodiments, the first array of OTA-TID values generated by the network device may be used to obfuscate real TIDs for downlink traffic transmitted from the network device to the STA.

In some embodiments, the STA may be configured to establish a second shared cryptographic key with the network device, and generate a second array of OTA-TID values by permuting the set of real TID values using the cryptographic function applied to the second shared cryptographic key and the current epoch identifier, where the second array of OTA-TID values is used to obfuscate real TIDs for uplink traffic transmitted from the STA to the network device.

In some embodiments, the network device may generate a third array of OTA-TID values by permuting the set of real TID values using the cryptographic function applied to the second shared cryptographic key and the current epoch identifier, and the third array is identical to the second array.

In some embodiments, the network device may comprise at least one of an access point (AP), a wireless controller, a gateway device, or a cloud-based server.

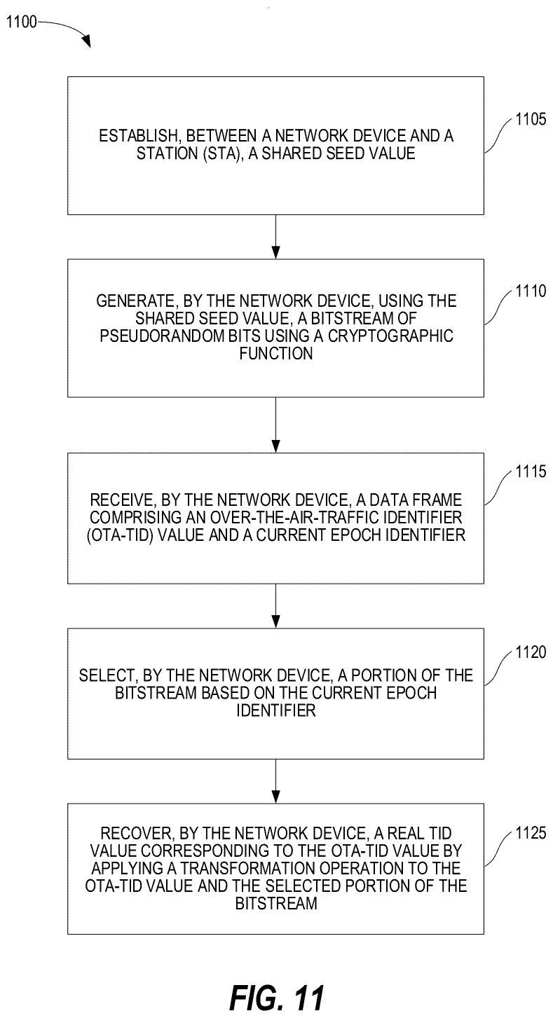

FIG. 11 is a block diagram depicting a method 1100 for bitstream generation and TID recovery using XOR-based obfuscation, according to some embodiments of the present disclosure.

At block 1105, a network device (e.g., 410 of FIG. 4) establishes a shared seed value (e.g., 415 of FIG. 4) with a station (STA) (e.g., 405 of FIG. 4).

At block 1110, the network device generates, using the shared seed value, a bitstream of pseudorandom bits (e.g., 420-2 of FIG. 4) using a cryptographic function.

At block 1115, the network device receives a data frame comprising an over-the-air-traffic identifier (OTA-TID) value and a current epoch identifier.

At block 1120, the network device selects a portion of the bitstream (e.g., 4^{th} chunk) based on the current epoch identifier.

At block 1125, the network device recovers a real TID value corresponding to the OTA-TID value by applying a transformation operation to the OTA-TID value and the selected portion of the bitstream.

In some embodiments, the STA may generate the OTA-TID by applying an inverse of the transformation operation to the real TID value using the selected portion of the bitstream.

In some embodiments, the transformation operation may comprise an exclusive-OR (XOR) operation, and the selected portion of the bitstream may comprise four bits selected based on a current epoch identifier.

In some embodiments, the transformation operation may comprise an exclusive-OR (XOR) operation, and the selected portion of the bitstream may comprise four bits selected based on one or more frame-specific parameters, comprising at least one of a sequence number or a packet number.

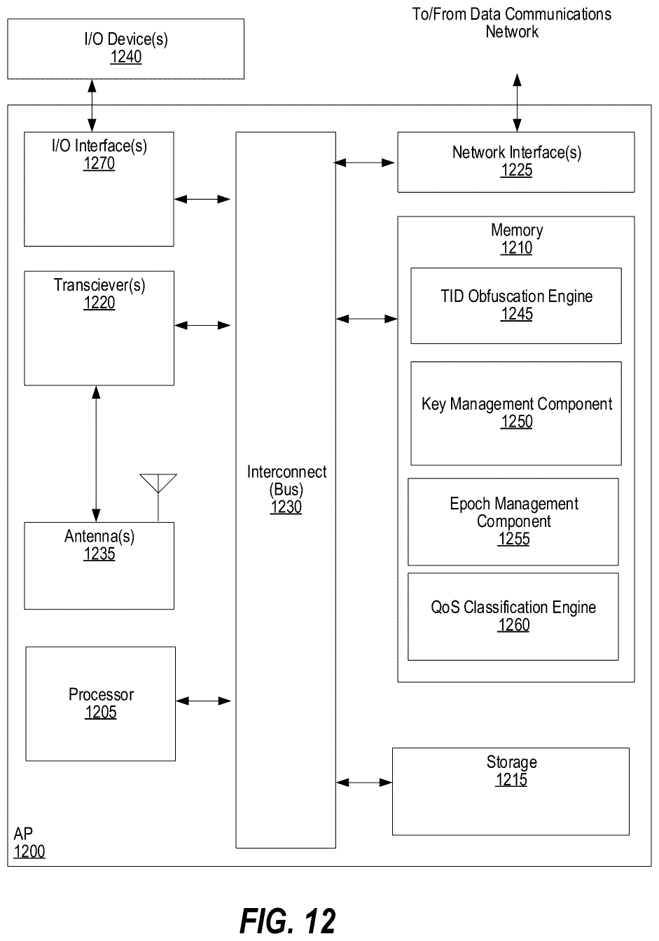

FIG. 12 depicts an example network device 1200 configured to perform various aspects of the present disclosure, according to some aspects of the present disclosure. The example network device 1200 may correspond to the AP 110-1 as depicted in FIG. 1, AP 310 as depicted in FIG. 3, AP 410 as depicted in FIG. 4, AP 510 as depicted in FIG. 5, or any other network device capable of managing TID obfuscation mappings (e.g., an AP of a MLD, or logical radio within a virtualized AP platform).

As illustrated, the network device 1200 includes a processor 1205, memory 1210, storage 1215, one or more transceivers 1220, one or more I/O interfaces 1280, and one or more network interfaces 1225. In some embodiments, I/O devices 1270 are connected via the I/O interface(s) 1280. Further, via the network interface 1225, the network device 1200 can be communicatively coupled with one or more other devices and components (e.g., via a network, which may include the Internet, local network(s), and the like). Each of the components is communicatively coupled by one or more buses 1230. In some embodiments, one or more antennas 1235 may be coupled to the transceivers 1220 for transmitting and receiving wireless signals.

The processor 1205 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1205 processes information received through the transceiver 1220, I/O interfaces 1280, and the network interfaces 1225. The processor 1205 retrieves and executes programming instructions stored in memory 1210, as well as stores and retrieves application data residing in storage 1215.

The storage 1215 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1215 may store a variety of data for the efficient functioning of the system.

The memory 1210 may include random access memory (RAM) and read-only memory (ROM). The memory 1210 may store processor-executable software code containing instructions that, when executed by the processor 1205, enable the network device 1200 to perform various functions described herein for wireless communication. The memory 1210 includes a TID obfuscation engine 1245, a key management component 1250, an epoch management component 1255, and a QoS classification engine 1260.

In one embodiment, the TID obfuscation engine 1245 is configured to perform TID mapping and transformation functions. More specifically, in one embodiment, the TID obfuscation engine 1245 generates, stores, and refreshes a 16×M transformation matrix for TID obfuscation (as depicted in FIG. 2). In one embodiment, the TID obfuscation engine 1245 applies permutation coding for matrix compression and manages transmission of the matrix to STAs. In one embodiment, the TID obfuscation engine 1245 generates TID permutations using a cryptographic function or CSPRNG seeded with a shared key (as depicted in FIG. 3). In one embodiment, the TID obfuscation engine 1245 first derives bitstreams from a shared seed and applies XOR-based transformation to real TIDs either on a per-epoch basis (as depicted in FIG. 4) or per-frame basis (as depicted in FIG. 5).

In one embodiment, the key management component 1250 is configured to establish and maintain cryptographic seeds (or keys) shared between the network device and each STA. The key management component 1250 may negotiate keys during association or secure handshake processes, generate direction-specific seeds (e.g., for UL and DL), and securely store them for use by the TID obfuscation engine 1245.

In one embodiment, the epoch management component 1255 is configured to maintain and synchronize the current epoch index for each STA. The epoch management component 1255 may track epoch progression based on local timers and provide consistent epoch values to the TID obfuscation engine 1245 during transmission and reception for accurate TID interpretation.

In one embodiment, the QoS classification engine 1260 is configured to process recovered real TIDs and assign corresponding traffic to MAC-layer access categories (ACs) in compliance with predefined standards.

Although depicted as a discrete component for conceptual clarity, in some embodiments, the operations of the depicted components (and others not illustrated) may be combined or distributed across any number of components. Further, although depicted as software residing in memory 1210, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
generating, by a network device, a first transformation matrix comprising a plurality of rows and a plurality of columns, each row corresponding to a real traffic identifier (TID) value, and each column corresponding to an epoch identifier within a sequence of epochs;
populating, by the network device, each entry of the first transformation matrix with an over-the-air-TID (OTA-TID) value, wherein each OTA-TID value is mapped from a respective TID and a respective epoch identifier; and
transmitting, by the network device, the first transformation matrix to a station (STA).

2. The method of claim 1, further comprising:
receiving, by the network device, a data frame from the STA, the data frame comprising a first OTA-TID value selected by the STA based on the transformation matrix; and
recovering, by the network device, a real TID value corresponding to the first OTA-TID value based on a respective epoch identifier associated with the data frame.

3. The method of claim 1, further comprising:
updating the first transformation matrix at a defined periodic interval, prior to expiration of the sequence of epochs represented in the transformation matrix.

4. The method of claim 1, further comprising:
receiving, by the network device, a second transformation matrix from the STA, the second transformation matrix being generated by the STA,
wherein the second transformation matrix comprises a plurality of rows and a plurality of columns, each row corresponding to the real TID value, and each column corresponding to an epoch identifier within a sequence of next epochs that is different from the sequence of epochs represented in the first transformation matrix generated by the network device.

5. The method of claim 4, wherein the first transformation matrix generated by the network device is used to obfuscate real TIDs for downlink traffic transmitted from the network device to the STA, and the second transformation matrix generated by the STA is used to obfuscate real TIDs for uplink traffic transmitted from the STA to the network device.

6. The method of claim 1, wherein the network device comprises at least one of an access point (AP), a wireless controller, a gateway device, or a cloud-based server.

7. The method of claim 1, wherein the network device generates the first transformation matrix in response to receiving a request from the STA, the request comprising one or more real TID values that the STA expects to use during the sequence of epochs, and within the first transformation matrix, each row corresponds to one of the TID values indicated in the request, and each column corresponds to an epoch identifier within the sequence of epochs.

8. The method of claim 1, further comprising:
transmitting, by the network device, a data frame to the STA, the data frame comprising a first OTA-TID value selected by the network device based on the transformation matrix, wherein the STA recovers a real TID value corresponding to the first OTA-TID value based on a respective epoch identifier associated with the data frame.

9. A method, comprising:
establishing, between a network device and a station (STA), a shared cryptographic key; and
generating, by the network device, a first array of over-the-air-traffic identifier (OTA-TID) values by permuting a set of real traffic identifier (TID) values using a cryptographic function applied to the shared cryptographic key and a current epoch identifier, wherein the first array defines a mapping from each real TID value to a corresponding OTA-TID value for a current epoch.

10. The method of claim 9, wherein the STA generates a second array of OTA-TID values by permuting the set of real TID values using the cryptographic function applied to the shared cryptographic key and the current epoch identifier, and the second array is identical to the first array.

11. The method of claim 10, further comprising:
receiving, by the network device and from the STA, a data frame comprising a first OTA-TID selected by the STA based on the second array; and
recovering, by the network device, a real TID corresponding to the first OTA-TID value using the first array and the current epoch identifier.

12. The method of claim 9, further comprising:
transmitting, by the network device, a data frame to the STA, the data frame comprising a first OTA-TID value selected by the network device based on the first array, wherein the STA recovers a real TID value corresponding to the first OTA-TID value using a second array and the current epoch identifier.

13. The method of claim 9, wherein the first array of OTA-TID values generated by the network device is used to obfuscate real TIDs for downlink traffic transmitted from the network device to the STA.

14. The method of claim 13, wherein the STA is configured to:
establish a second shared cryptographic key with the network device, and
generate a second array of OTA-TID values by permuting the set of real TID values using the cryptographic function applied to the second shared cryptographic key and the current epoch identifier, wherein the second array of OTA-TID values is used to obfuscate real TIDs for uplink traffic transmitted from the STA to the network device.

15. The method of claim 14, wherein the network device generates a third array of OTA-TID values by permuting the set of real TID values using the cryptographic function applied to the second shared cryptographic key and the current epoch identifier, and the third array is identical to the second array.

16. The method of claim 9, wherein the network device comprises at least one of an access point (AP), a wireless controller, a gateway device, or a cloud-based server.

17. A method, comprising:
establishing, between a network device and a station (STA), a shared seed value;
generating, by the network device, using the shared seed value, a bitstream of pseudorandom bits using a cryptographic function;
receiving, by the network device, a data frame comprising an over-the-air-traffic identifier (OTA-TID) value and a current epoch identifier;
selecting, by the network device, a portion of the bitstream based on the current epoch identifier; and
recovering, by the network device, a real TID value corresponding to the OTA-TID value by applying a transformation operation to the OTA-TID value and the selected portion of the bitstream.

18. The method of claim 17, wherein the STA generates the OTA-TID by applying an inverse of the transformation operation to the real TID value using the selected portion of the bitstream.

19. The method of claim 17, wherein the transformation operation comprises an exclusive-OR (XOR) operation, and the selected portion of the bitstream comprises four bits selected based on a current epoch identifier.

20. The method of claim 17, wherein the transformation operation comprises an exclusive-OR (XOR) operation, and the selected portion of the bitstream comprises four bits selected based on one or more frame-specific parameters, comprising at least one of a sequence number or a packet number.
